(19) United States
(12) Patent Application Publication
(10) Pub. No.: US 2010/0283846 A1
(43) Pub. Date: Nov. 11, 2010

(54) ROTARY BODY MEASURING DEVICE

(75) Inventor: Kou Yamagishi, Kyoto (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: Kou Yamagishi, Kyoto-shi, Kyoto (JP)

(21) Appl. No.: 12/667,427

(22) PCT Filed: May 15, 2009
(86) PCT No.: PCT/JP2008/058918

§ 371 Date: Dec. 31, 2009

(30) Foreign Application Priority Data
Jul. 26, 2007 (JP) 2007-194421

(51) Int. Cl. H04N 7/18

(52) U.S. Cl. 348/142; 348/E07.085

(57) ABSTRACT

An excellent rotary body measuring device is provided which is capable of properly observing and measuring a desired position of a rotary body in a rotating state from a required direction with use of a simplified device structure. The rotary body measuring device includes: an optical system (OP) having an objective lens (1) at a front end thereof and a half mirror (2) as a light guide in/out section at an intermediate portion thereof; a camera (3) as image obtaining means optically connected to a base end side of the optical system (OP); and a blinking light source (4) provided to introduce blinking light (X) into the half mirror (2), wherein the blinking light (X) from the blinking light source (4) is guided out from a front end side of the optical system (OP) via the half mirror (2) so as to be applied to a rotary body (R) in a rotating state as an object to be measured through a clearance, and then reflected blinking light (X′) is taken into the camera (3) in a measurable form through the objective lens (1) and half mirror (2) of the optical system (OP), whereby the rotary body (R) in a virtually stopped state can be measured.

### TECHNICAL FIELD

The present invention relates to a rotary body measuring device configured to be capable of properly measuring a rotary body in a rotating state.

### BACKGROUND ART

A rotary body measuring device disclosed in patent document 1 for example is known.

This device is configured to monitor a tool's cutting tip and includes a light source device 41 for illuminating an object T to be imaged, an imaging device 21 for converting an image formed on a light-receiving surface to an electric signal, optical means for forming the image of the object T on the light-receiving surface of the imaging device 21, and a housing 1 accommodating therein the imaging device 21 and the optical means while holding the light source device 41. The optical means comprises an incident-side reflecting mirror 33, an objective lens 30a placed rearwardly of the incident-side reflecting mirror 33, an imaging lens 30b, and an outgoing-side reflecting mirror 36 placed rearwardly of the imaging lens 30b, as illustrated in FIG. 1 of the patent document. Light incident on the incident-side reflecting mirror 33 outgoes from the outgoing-side reflecting mirror 36 in a direction opposite to the direction of incidence of the light. Since the directions of travels of light from the incident-side reflecting mirror 33 toward the object T and from the outgoing-side reflecting mirror 36 toward the imaging device 21 are opposite to each other, the measuring device is not so elongated in one direction and hence can be rendered compact.

That is, the measuring device of patent document 1 is characterized in that its housing is rendered compact as compared to conventional structures illustrated in FIGS. 2(a) and 2(b) of the patent document by employing an optical system configured to cause incident light and outgoing light to travel in reverse directions as illustrated in FIG. 2(c) of the patent document. The measuring device is capable of selectively using one of a back light unit 4 and a front light unit 5 as a light source, as illustrated in FIG. 2(c). When the former is used, the measuring device detects the position of the object T from the contour of the object T. When the latter is used, the measuring device detects a defect on a surface of the object T, such as a foreign substance adhering thereto or a flaw, by illuminating an imaged surface of the object T. A camera 2 includes an image signal generating circuit configured to convert an electric signal generated by the imaging device 21 to image data of a predetermined format, which in turn is transferred to an external image processing device through a cable C. The back light unit 4 is used to detect the position of a cutting tool from the contour of the cutting tool in a rotating state, while the front light unit 5 used to detect a defect on the cutting tool in a stationary state such as a foreign substance adhering thereto or a flaw. Patent Document 1: Japanese Patent Laid-Open Publication No. 2007-49489

### DISCLOSURE OF THE INVENTION

### Problems to be Solved by the Invention

With such a structure only, however, it is not possible to observe the surface of the cutting tool in a rotating state. It is conceivable that a high-speed shutter CCD camera is used as the camera 2 in order to perform processing on continuously reflected light of the front light unit 5. However, this type of camera is structured to reproduce an image once recorded, needs a number of memory devices, and has to perform complicated image processing. For this reason, the measuring device with such a camera has a limitation on the time that can be afforded to a one-time measurement and inevitably costs high.

Since the measuring device of the patent document noted above has an integral structure which allows a cutting tip to intervene between the light source and the light-receiving section which are spaced apart from each other by a fixed distance, the measuring device can only perform imaging from a lateral side of a cutting edge or from a predetermined oblique angle and hence has a problem of a very low degree of freedom to image, for example, the tip surface of the cutting edge from an axial direction or from any other direction as desired, or to image a tilted cutting tool. Further, the use of plural light sources causes the required parts count to increase and hence makes the measuring device bulky. What is more, the light-receiving section is structured to cause light to be refracted at a mirror and then pass through the objective lens in order to avoid upsizing of the overall device which would occur when the light-receiving section is located apart from the back light unit by a certain distance. For this reason, the measuring device has a structure incorporating the objective lens therein and hence has a problem that the lens can not easily be replaced with a lens of a different magnification.

Furthermore, since a light source, such as the front light unit, and the light-receiving section are present on different optical axes, the objective lens cannot be brought closer to the object to a certain extent or more because of the physical interference between the light source and the light-receiving section, relative positional relation between the optical axes, and the like. This is also a factor of impediment to free imaging.

An object of the present invention is to provide a rotary body measuring device which has solved these problems effectively.

### MEANS FOR SOLVING THE PROBLEMS

In order to attain the foregoing object, the present invention provides the following means.

That is, a rotary body measuring device according to the present invention is characterized by comprising: an optical system having an objective lens at a front end thereof and a light guide in/out section at an intermediate portion thereof; image obtaining means optically connected to a base end side of the optical system; and a blinking light source provided to introduce blinking light into the light guide in/out section, wherein the blinking light from the blinking light source is guided out from a front end side of the optical system via the light guide in/out section so as to be applied to a rotary body in a rotating state as an object to be measured through a clearance, and then the blinking light reflected is taken into the image obtaining means in a measurable form through the objective lens and the light guide in/out section of the optical system, whereby the rotary body in a virtually stopped state can be measured.

The measuring device thus constructed makes it possible to perform measurement with the objective lens brought as close to the rotary body as possible unlike a case where the rotary body is illuminated from an oblique direction relative to the light-receiving direction because the light application direction and the light-receiving direction are coincident with each other. Since the measuring device applies blinking light from the objective lens to the rotary body through the clearance and receives the blinking light reflected from the rotary body, it becomes possible to measure an appropriate portion of the rotary body by adjusting the position and orientation of the objective lens relative to the rotary body, thereby to properly accommodate to a case where the rotation axis of the rotary body is tilted and a like case. Further, unlike measurement based on a silhouette, the present measuring device utilizes reflected light and hence is capable of observing not only the contour but also the surface condition of the rotary body with use of a single light source. What is more, since the measuring device needs only one light source, it becomes possible to effectively reduce the parts count and render the device compact.

For further compactification and cost reduction, the image obtaining means is desirably configured to generate an image or an image signal in real time through photoelectric conversion from received light without a recording and reproduction process.

For remarkable improvement in the convenience of handling, the measuring device preferably has an arrangement wherein the optical system, the image obtaining means and the blinking light source are provided integrally with a casing in such a manner as to allow measurement conditions to be established for measurements from suitable directions relative to respective of appropriate portions of the rotary body as the object to be measured, including a measurement of a lateral side of the rotary body from a direction orthogonal to a rotation axis of the rotary body, a measurement of an end face of the rotary body from an axial direction along the rotation axis, and a measurement from an intermediate angle between those directions, by appropriately fixing position and orientation of the casing.

For effectively preventing the overall device from becoming bulky, the measuring device preferably has an arrangement wherein an optical axis of the optical system from the image obtaining means to the objective lens extends linearly, while the blinking light from the blinking light source is outputted along the optical axis, refracted at an intermediate point and then guided out along the optical axis via the light guide in/out section.

For the measuring device to be applicable to different types of rotary bodies, it is desirable that the objective lens forming an end portion of the optical system be removably mounted on the casing.

### Advantage(s) of the Invention

The present invention having the construction described above makes it possible to provide an excellent rotary body measuring device capable of properly observing and measuring a desired portion of a rotary body in a rotating state from a required direction by employing a simplified device structure.

### BRIEF DESCRIPTION OF THE DRAWINGS

FIG. 1 is a perspective view illustrating a measuring device according to one embodiment of the present invention;

FIG. 2 is a view schematically illustrating an internal structure of the measuring device;

FIG. 3 is a view illustrating a camera and a blinking light source of the measuring device for showing the principle of the measuring device;

FIG. 4 is an explanatory view illustrating operations of the embodiment;

FIG. 5 is a view illustrating a variation embodiment of the present invention; and

FIG. 6 is a view illustrating another variation embodiment of the present invention.

### BEST MODE FOR CARRYING OUT THE INVENTION

Hereinafter, one embodiment of the present invention will be described with reference to the drawings.

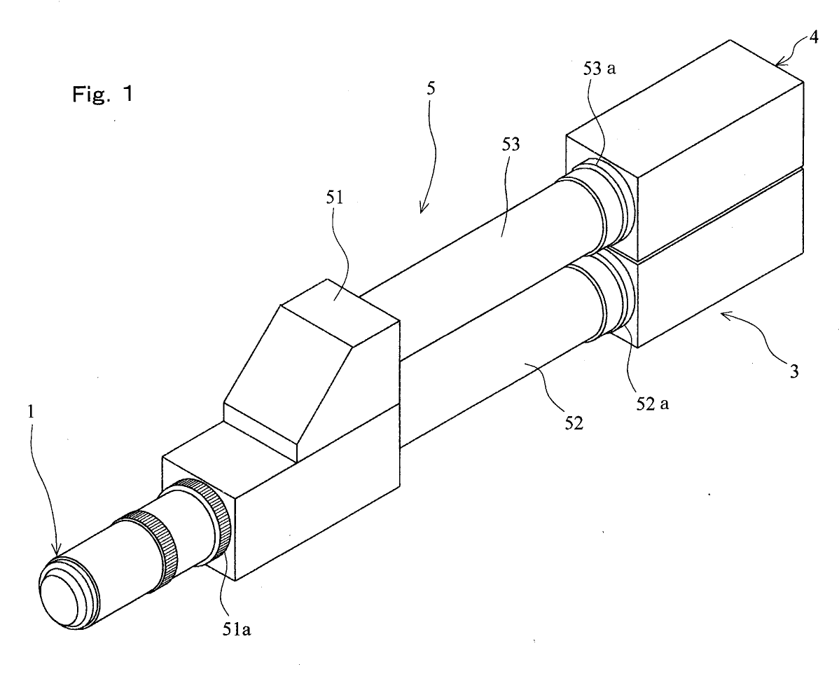

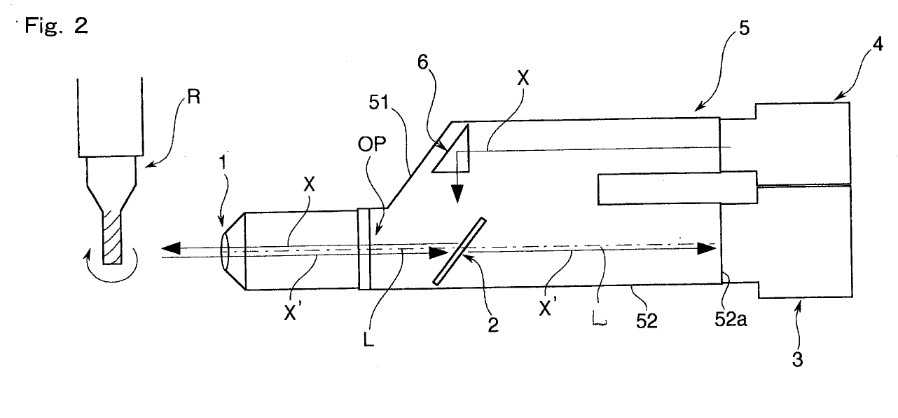

As illustrated in FIGS. 1 and 2, a measuring device according to the present embodiment includes a casing 5 provided integrally with: an optical system OP having an objective lens 1 at a front end thereof and a half mirror 2 as a light guide in/out section at an intermediate portion thereof; a camera 3 as image obtaining means connected to a base end side of the optical system OP so as to obtain an image in a measurable form; and a blinking light source 4 provided to introduce blinking light into the half mirror 2.

Specifically speaking, the casing 5 comprises a casing body 51 having a hollow block shape, and two light guide tubes 52 and 53 joined to the casing body 51 so as to extend parallel with each other. A lens mount portion 51a and a camera mount portion 52a are formed on the front end side of the casing body 51 and the base end side of the light guide tube 52, respectively, to provide an optical axis L extending linearly between the lens mount portion 51a and the camera mount portion 52a.

The optical system OP has the objective lens 1 removably mounted on the lens mount portion 51a, and the half mirror 2 placed in the casing body 51 in such a manner as spaced a predetermined distance apart from the objective lens 1 and as inclined 45° relative to the optical axis L. The half mirror 2 serves to reflect light incident thereon from a direction orthogonal to the optical axis L in a direction along the optical axis L while allowing light incident thereon from the objective lens 1 along the optical axis L to pass therethrough along the optical axis L without reflection.

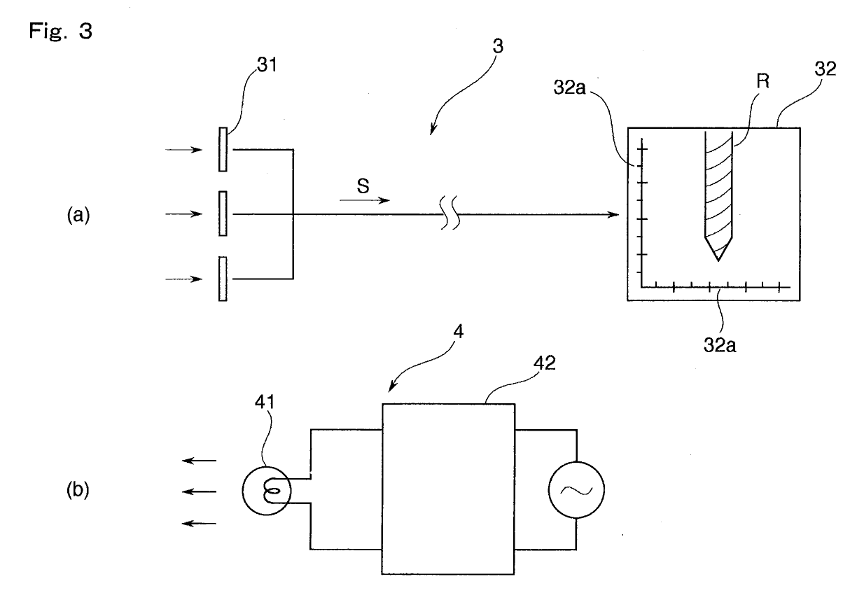

As schematically illustrated in FIG. 3(a), the camera 3 has a CCD 31 therein and is imparted with the function of receiving light incident thereon through the optical system OP by the CCD 31 and performing photoelectric conversion of the light to an image signal S. The camera 3 used in this embodiment is provided with a monitor 32 for displaying an image in response to the image signal S thus converted. The monitor 32 is configured to display an appropriate scale 32a or the like in order to make measurement based on visual observation possible. In the present embodiment, the image signal, CCD 31 and monitor 32 are adapted to color images.

As schematically illustrated in FIG. 3(b), the blinking light source 4 comprises an appropriate light source device 41 of a short flashing duration and is mounted on a light source mount portion 53a formed on the base end side of the light guide tube 53 illustrated in FIGS. 1 and 2. The casing body 51 is provided therein with a prism 6 which causes blinking light X emitted from the blinking light source 4 in parallel with the optical axis L of the optical system OP to be refracted by 90° . After the refraction, the blinking light X reaches the half mirror 2 and is reflected by 90° at the half mirror 2 so as to be guided out along the optical axis L through the objective lens 1. As illustrated in FIG. 3(b), the blinking light source 4 incorporates a control circuit 42 for causing the light source device 41 to blink in accordance with the number of revolutions (i.e., rotating speed) of a rotary body R as an object to be measured. The control circuit 42 has appropriate functions including the function of fine adjustment of the phase and period of emission of blinking light. The prism 6 and the half mirror 2 form a so-called beam splitter.

With the present measuring device, when blinking light X is applied to, for example, the rotary body R (e.g., a cutting tool such as an end mill) in a rotating state as the object to be measured, reflected light X′ thereof becomes incident on the objective lens 1 and then passes through the half mirror 2. The image of the rotary body R as the object to be measured is received by the CCD of the camera 3, converted to the image signal S, and displayed on the monitor 32 in real time. The blinking light source 4 has a stroboscopic function by which light is emitted synchronously with revolutions of the rotary body R and, hence, the image displayed on the monitor 32 is an image of the rotary body R in a virtually stopped state. It is also possible to adjust the stopped phase of the rotary body R. The monitor 32 allows the dimensions of the rotary body R such as a cutting tool to be measured using the scale 32a displayed thereon and enables the surface condition of the rotary body R to be observed. The measuring device can accommodate to a high speed rotation of not less than 100,000 rpm as long as the functions of the blinking light source 4 are secured therefor.

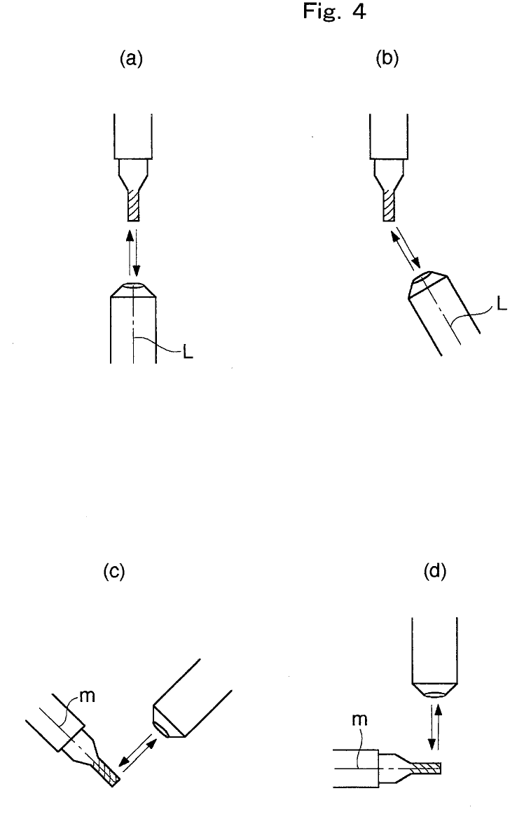

Since constituent parts of the measuring device are incorporated in the casing 5, they can be handled as one piece. Therefore, the measuring device is capable of measurement by merely directing the objective lens 1 at the object to be measured. For this reason, the rotation axis m of the rotary body R as the object to be measured need not necessarily be positioned orthogonal to the optical axis L of the present device. Thus, the measuring device can measure and observe either the tip end surface of the rotary body R from an axial direction along the axis m when the device is positioned so as to orient the optical axis L vertically upward as illustrated in FIG. 4(a) or a portion around the tip of the rotary body R from an oblique direction when the device is positioned so as to orient the optical axis L obliquely as illustrated in FIG. 4(b), in addition to measurement from a lateral side of the rotary body R as illustrated in FIG. 2. The rotation axis m of the rotary body R as the object to be measured need not necessarily assume a vertical position as illustrated in FIG. 2. The measuring device can measure and observe the rotary body R assuming such a position that the rotation axis m is tilted relative to the vertical direction as illustrated in FIG. 4(c) for example or such a position that the rotation axis m extends horizontally as illustrated in FIG. 4(d) from a respective one of suitable directions.

As described above, the measuring device according to the present embodiment comprises: the optical system OP having the objective lens 1 at the front end thereof and the half mirror 2 as the light guide in/out section at the intermediate portion thereof; the camera 3 as the image obtaining means optically connected to the base end side of the optical system OP; and the blinking light source 4 provided to introduce blinking light X into the half mirror 2, wherein the blinking light X from the blinking light source 4 is guided out from the front end side of the optical system OP via the half mirror 2 so as to be applied to the rotary body R in a rotating state as the object to be measured through a clearance, and then reflected blinking light X′ is taken into the camera 3 in a measurable form through the objective lens 1 and half mirror 2 of the optical system OP, whereby the rotary body R in a virtually stopped state can be measured.

This construction makes it possible to perform measurement with the objective lens 1 brought as close to the rotary body R as possible unlike a case where the rotary body R is illuminated from an oblique direction relative to the light-receiving direction because the light application direction and the light-receiving direction are coincident with each other. Since the measuring device applies the blinking light X from the objective lens 1 to the rotary body R through the clearance and receives the reflected light X′ thereof, it becomes possible to measure an appropriate portion of the rotary body R by adjusting the position and orientation of the objective lens 1 relative to the rotary body R, thereby to properly accommodate to a case where the rotation axis m of the rotary body R is tilted and a like case. Further, unlike measurement based on a silhouette, the present measuring device utilizes reflected light X′ and hence is capable of observing not only the contour but also the surface condition of the rotary body R with use of a single light source. What is more, since the measuring device needs only one light source, it becomes possible to effectively reduce the parts count and the cost, as well as to effectively render the device compact.

Since the camera 3 is configured to generate the image signal S as well as the corresponding image from the received light X′ in real time through photoelectric conversion, there is no need to provide the function of recording image data items one by one. Unlike cases where image data has to be recorded and then reproduced, the present measuring device has no limitation on the measurement time and has a minimized device configuration from which the constituent parts required for recording and reproduction have been eliminated as many as possible, thus making it possible to realize a substantial reduction in cost.

In recent years, improvements have been made in the technique of manufacturing very small cutting tools. In view of the fact that there has been no existing simple device which is capable of measuring such a very small cutting tool based on its image in real time, the measuring device according to the present embodiment can be utilized very usefully.

Further, the present measuring device has an arrangement wherein the optical system OP, camera 3 and blinking light source 4 are provided integrally with the casing 5 in such a manner as to allow measurement conditions to be established for measurements from suitable directions relative to respective of appropriate portions of the rotary body R as the object to be measured, including a measurement of a lateral side of the rotary body R from a direction orthogonal to the rotation axis m of the rotary body R, a measurement of an end face of the rotary body R from an axial direction along the rotation axis m, and a measurement from an intermediate angle between those directions, by appropriately fixing the position and orientation of the casing 5. That is, the measuring device employs a dry measurement mechanism to measure the reflected light X′ and has the casing 5 integral with the constituent parts required for the process from light emission to light receiving, including the objective lens 1 located at the end portion of the device, thereby enabling setting suitable for any one of various target portions to be easily completed by merely fixing the casing 5 in appropriate position and orientation.

The measuring device may have an arrangement wherein the optical axis L of the optical system OP from the camera 3 to the objective lens 1 extends linearly, while the blinking light X from the blinking light source 4 is outputted along the optical axis L, refracted at an intermediate point and then guided out along the optical axis L via the half mirror 2. When the two light guide tubes are joined to each other at an intermediate point to form a guide path, those portions of the light guide tubes 52 and 53 which extend from the branch portion toward the base end side can be positioned parallel with each other. Therefore, the overall device can be more effectively prevented from becoming bulky than a case where the light guide tubes 52 and 53 cross each other so as to introduce the blinking light X from the blinking light source 4 from a direction orthogonal to the optical axis L.

With the above-described arrangements taken as preconditions, the objective lens 1 forming an end portion of the optical system OP is removably mounted as exposed at an end portion of the casing 5. For this reason, the measuring device allows the objective lens 1 to be replaced with another one of a different magnification and hence can be excellent in convenience of use while keeping the overall body compact.

It is needless to say that the measuring device according to the present embodiment is capable of measuring and observing the rotary body R which assumes a stationary state by stopping rotation.

While one embodiment of the present invention has been described above, the specific structure or feature of each part of the device is not limited to the embodiment described above.

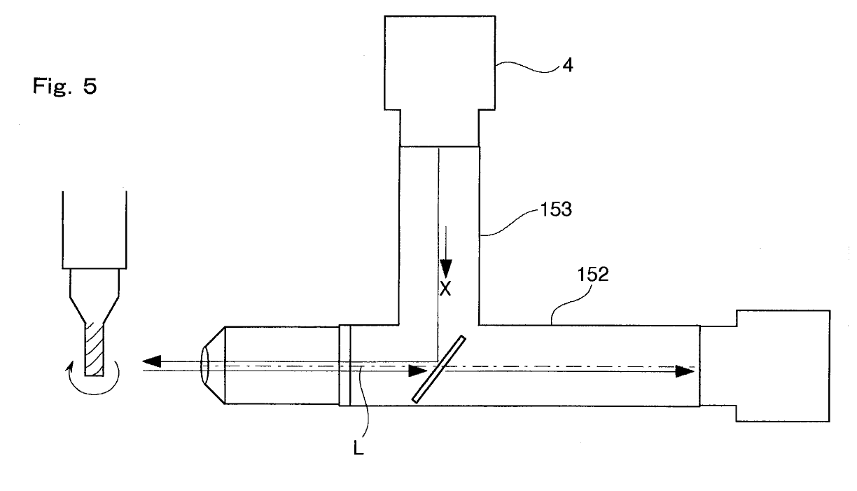

For example, if restrictions on the incorporation of the constituent parts are not so severe, the present invention does not preclude any such structure as shown in FIG. 5 in which the light guide tubes 152 and 153 cross each other so as to introduce the blinking light X from the blinking light source 4 from a direction orthogonal to the optical axis L when the two light guide tubes are joined to each other at an intermediate point to form the guide path.

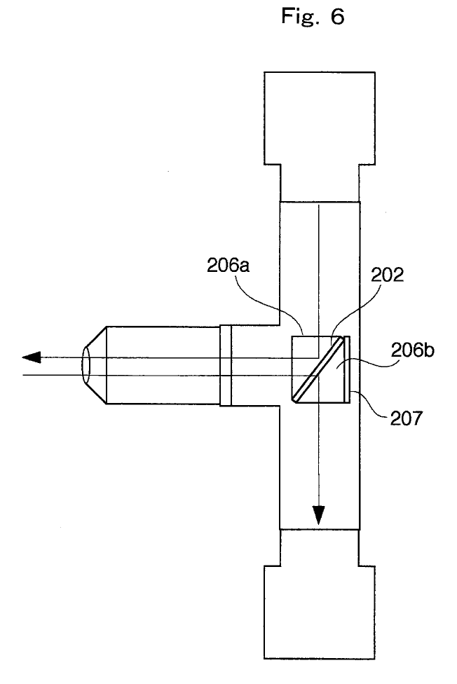

A combination of a half mirror 202 and prisms 206a and 206b as shown in FIG. 6 may be used so as to function as the beam splitter. Reference numeral 207 in FIG. 6 designates a mirror. Likewise, the specific structure of the beam splitter may be appropriately varied.

Various variations are possible without departing from the concept of the present invention. For example, it is possible to place the present measuring device on a two- or three-dimensionally movable table, mount the measuring device swingably so as to change the measuring direction, or provide the measuring device with a computer by means of which measurement and observation are performed based on an image signal transmitted from the image obtaining means to the computer.

### INDUSTRIAL APPLICABILITY

The present invention having been described above makes it possible to provide an excellent rotary body measuring device which is capable of properly observing and measuring a desired portion of a rotary body in a rotating state from a required direction by employing a simplified device structure.

1. A rotary body measuring device characterized by comprising: an optical system having an objective lens at a front end thereof and a light guide in/out section at an intermediate portion thereof; image obtaining means optically connected to a base end side of the optical system; and a blinking light source provided to introduce blinking light into the light guide in/out section, wherein the blinking light from the blinking light source is guided out from a front end side of the optical system via the light guide in/out section so as to be applied to a rotary body in a rotating state as an object to be measured through a clearance, and then the blinking light reflected is taken into the image obtaining means in a measurable form through the objective lens and the light guide in/out section of the optical system, whereby the rotary body in a virtually stopped state can be measured.

2. The rotary body measuring device according to claim 1, wherein the image obtaining means is configured to generate an image or an image signal in real time through photoelectric conversion from received light.

3. The rotary body measuring device according to claim 1 or 2, wherein the optical system, the image obtaining means and the blinking light source are provided integrally with a casing in such a manner as to allow measurement conditions to be established for measurements from suitable directions relative to respective of appropriate portions of the rotary body as the object to be measured, including a measurement of a lateral side of the rotary body from a direction orthogonal to a rotation axis of the rotary body, a measurement of an end face of the rotary body from an axial direction along the rotation axis, and a measurement from an intermediate angle between those directions, by appropriately fixing position and orientation of the casing.

4-5. (canceled)

6. The rotary body measuring device according to claim 2, wherein the optical system, the image obtaining means and the blinking light source are provided integrally with a casing in such a manner as to allow measurement conditions to be established for measurements from suitable directions relative to respective of appropriate portions of the rotary body as the object to be measured, including a measurement of a lateral side of the rotary body from a direction orthogonal to a rotation axis of the rotary body, a measurement of an end face of the rotary body from an axial direction along the rotation axis, and a measurement from an intermediate angle between those directions, by appropriately fixing position and orientation of the casing.

7. The rotary body measuring device according to claim 1, wherein an optical axis of the optical system from the image obtaining means to the objective lens extends linearly, while the blinking light from the blinking light source is outputted along the optical axis, refracted at an intermediate point and then guided out along the optical axis via the light guide in/out section.

8. The rotary body measuring device according to claim 2, wherein an optical axis of the optical system from the image obtaining means to the objective lens extends linearly, while the blinking light from the blinking light source is outputted along the optical axis, refracted at an intermediate point and then guided out along the optical axis via the light guide in/out section.

9. The rotary body measuring device according to claim 3, wherein an optical axis of the optical system from the image obtaining means to the objective lens extends linearly, while the blinking light from the blinking light source is outputted along the optical axis, refracted at an intermediate point and then guided out along the optical axis via the light guide in/out section.

10. The rotary body measuring device according to claim 6, wherein an optical axis of the optical system from the image obtaining means to the objective lens extends linearly, while the blinking light from the blinking light source is outputted along the optical axis, refracted at an intermediate point and then guided out along the optical axis via the light guide in/out section.

11. The rotary body measuring device according to claim 1, wherein the objective lens forming an end portion of the optical system is removably mounted on the casing.

12. The rotary body measuring device according to claim 2, wherein the objective lens forming an end portion of the optical system is removably mounted on the casing.

13. The rotary body measuring device according to claim 3, wherein the objective lens forming an end portion of the optical system is removably mounted on the casing.

14. The rotary body measuring device according to claim 6, wherein the objective lens forming an end portion of the optical system is removably mounted on the casing.

15. The rotary body measuring device according to claim 7, wherein the objective lens forming an end portion of the optical system is removably mounted on the casing.

16. The rotary body measuring device according to claim 8, wherein the objective lens forming an end portion of the optical system is removably mounted on the casing.

17. The rotary body measuring device according to claim 9, wherein the objective lens forming an end portion of the optical system is removably mounted on the casing.

18. The rotary body measuring device according to claim 10, wherein the objective lens forming an end portion of the optical system is removably mounted on the casing.
